(19) United States
(12) Patent Application Publication
(10) Pub. No.: US 2022/0027774 A1
(43) Pub. Date: Jan. 27, 2022

(54) QUANTUM CONTROL PULSE GENERATION METHOD, DEVICE, AND STORAGE MEDIUM

(71) Applicant: BEIJING BAIDU NETCOM SCIENCE TECHNOLOGY CO., LTD., Beijing (CN)

(72) Inventors: Lijing JIN, Beijing (CN); Xin WANG, Beijing (CN); Runze ZHANG, Beijing (CN); Zelin MENG, Beijing (CN)

(21) Appl. No.: 17/450,157

(22) Filed: Oct. 6, 2021

(30) Foreign Application Priority Data
Jan. 22, 2021 (CN) 202110090999.3

(51) Int. Cl. G06N 10/00; G06F 9/455

(52) U.S. Cl. CPC G06N 10/00; G06F 9/455

(57) ABSTRACT

A quantum control pulse generation method, a device, and a storage medium are provided, which are related to the field of quantum computation. The method includes: constructing, based on relevant physical parameters of a target quantum hardware structure, a system Hamiltonian of a quantum system characterized by the target quantum hardware structure; obtaining an initial control pulse set matching the target quantum hardware structure; obtaining, based on the system Hamiltonian, system state information of the quantum system by simulation; and optimizing the initial control pulse in the initial control pulse set based on at least a relationship between the system state information of the quantum system and target state information that needs to be achieved by the target quantum task, to obtain a target control pulse sequence by simulation.

### CROSS-REFERENCE TO RELATED APPLICATIONS

This application claims priority to Chinese patent application, No. 202110090999.3, entitled “Quantum Control Pulse Generation Method and Apparatus, Device, and Storage Medium”, filed with the Chinese Patent Office on Jan. 22, 2021, which is hereby incorporated by reference in its entirety.

### TECHNICAL FIELD

The present disclosure relates to a technical field of data processing, in particular, to a field of quantum computation.

### BACKGROUND

Quantum computation is considered to be the heart of the next generation of computing technology, and it is also a representative technology leading a new generation of quantum revolution. In recent years, significant progress has been made in fields of quantum computing software and hardware, and the quantum computation has entered a Noise Intermediate-Scale Quantum (NISQ) era. At the level of quantum computing software, a variety of quantum algorithms that can be applied in the near future and various quantum cloud platforms have been developed and implemented successively. At the level of quantum computing hardware, there are many different types of quantum hardware candidates in the industry, which includes a superconducting circuit, an ion trap, a photon, an NV color center, a nuclear magnetic resonance, and the like. Different technical routes present different advantages. Certainly, there are corresponding challenges.

### SUMMARY

According to the present disclosure, it is provided a quantum control pulse generation method and apparatus, a device, and a storage medium.

According to an aspect of the present disclosure, it is provided a quantum control pulse generation method, including:

constructing, based on relevant physical parameters of a target quantum hardware structure, a system Hamiltonian of a quantum system characterized by the target quantum hardware structure, wherein the target quantum hardware structure is used to achieve a target quantum task;

obtaining an initial control pulse set matching the target quantum hardware structure, wherein the initial control pulse set includes at least one initial control pulse used to be applied to a qubit in the target quantum hardware structure;

obtaining, based on the system Hamiltonian, system state information of the quantum system by simulation, wherein the system state information characterizes state information of the quantum system obtained by simulation after an application of the initial control pulse to the qubit in the target quantum hardware structure; and

optimizing the initial control pulse in the initial control pulse set based on at least a relationship between the system state information of the quantum system and target state information that needs to be achieved by the target quantum task, to obtain a target control pulse sequence by simulation, wherein the target quantum task can be achieved after the target control pulse sequence is applied to the qubit in the target quantum hardware structure.

According to another aspect of the present disclosure, it is provided a quantum control pulse generation apparatus, including:

a physical quantity construction unit, configured for constructing, based on relevant physical parameters of a target quantum hardware structure, a system Hamiltonian of a quantum system characterized by the target quantum hardware structure, wherein the target quantum hardware structure is used to achieve a target quantum task;

an initial pulse obtaining unit, configured for obtaining an initial control pulse set matching the target quantum hardware structure, wherein the initial control pulse set includes at least one initial control pulse used to be applied to a qubit in the target quantum hardware structure;

a computation unit, configured for obtaining, based on the system Hamiltonian, system state information of the quantum system by simulation, wherein the system state information characterizes state information of the quantum system obtained by simulation after an application of the initial control pulse to the qubit in the target quantum hardware structure; and

a pulse optimization unit, configured for optimizing the initial control pulse in the initial control pulse set based on at least a relationship between the system state information of the quantum system and target state information that needs to be achieved by the target quantum task, to obtain a target control pulse sequence by simulation, wherein the target quantum task can be achieved after the target control pulse sequence is applied to the qubit in the target quantum hardware structure.

According to another aspect of the present disclosure, it is provided an electronic device, including:

at least one processor; and

a memory communicatively connected to the at least one processor, wherein

the memory stores instructions executable by the at least one processor, and the instructions are executed by the at least one processor to enable the at least one processor to perform the method provided in any one of embodiments of the present disclosure.

According to another aspect of the present disclosure, there is provided a non-transitory computer-readable storage medium storing computer instructions, wherein the computer instructions, when executed by a computer, enable the computer to perform the method provided in any one of embodiments of the present disclosure.

According to another aspect of the present disclosure, it is provided a computer program product including a computer program, wherein the computer program, when executed by a processor, enable the processor to implement a method in any one of embodiments of the present disclosure.

It should be understood that the content described in this section is not intended to identify the key or critical features of embodiments of the present disclosure, nor is it intended to limit the scope of the disclosure. Other features of the present disclosure will become readily apparent from the following description.

### BRIEF DESCRIPTION OF THE DRAWINGS

The accompanying drawings are included to provide a better understanding of the scheme and are not to be construed as limiting the present disclosure. In the drawings:

FIG. 1 is a schematic flowchart showing an implementation of a quantum control pulse generation method according to an embodiment of the present disclosure;

FIG. 2 is schematic structural diagram showing quantum computing software for implementing a quantum control pulse generation method according to an embodiment of the present disclosure;

FIG. 3 is schematic flowchart showing an implementation in a specific example of a quantum control pulse generation method according to an embodiment of the present disclosure;

FIG. 4 and FIG. 5 are chromatograms of a density matrix in a specific example according to an embodiment of the present disclosure;

FIG. 6 is a schematic structural diagram showing a quantum control pulse generation apparatus according to an embodiment of the present disclosure; and

FIG. 7 is a block diagram of an electronic device for implementing a quantum control pulse generation method according to an embodiment of the present disclosure.

### DETAILED DESCRIPTION

The following describes exemplary embodiments of the present disclosure with reference to the accompanying drawings, which includes various details of embodiments of the present disclosure to facilitate understanding and should be considered as merely exemplary. Accordingly, one of ordinary skilled in the art appreciates that various changes and modifications can be made to the embodiments described herein without departing from the scope and spirit of the present disclosure. Similarly, descriptions of well-known functions and structures are omitted from the following description for clarity and conciseness.

In quantum control, a core problem that usually needs to be resolved is to achieve a specific quantum task, it is necessary to design technical schemes to convert a quantum logic gate in a pre-built logic quantum circuit into a high-fidelity pulse instruction that can be executed by quantum hardware, and in turns to implement the quantum logic gate. However, generally, existing quantum hardware manufacturers do not have pulse optimization schemes on software and hardware interfaces, and non-ideal factors are not fully considered in a compilation process from the quantum logic gate to an actual control pulses, which will undoubtedly affect the fidelity of the quantum gate obtained based on the control pulse. To complete a given quantum task, users need to do a lot of advanced developments for related interfaces. Furthermore, there are different structures and parameters of quantum computing hardware, as well as inconsistency of external interface standards, and each platform has not formed a complete and unified pulse scheme, which undoubtedly increases the cost of using and developing existing platforms, and reduces user experience.

Based on this, according to the scheme of the present disclosure, it is provided a quantum control scheme (namely, a quantum control pulse generation method apparatus, a device, a storage medium, and a product) that may be applied to a real quantum computer. It is suitable for various types of quantum hardware (such as a superconducting circuit, an ion trap, and nuclear magnetic resonance) to generate a required high-fidelity target control pulse sequence at a faster speed, and to achieve a given quantum task based on the generated target control pulse sequence. Further, the fidelity of a given quantum system (that is, a quantum system indicated by the given quantum hardware), and its related results can be analyzed based on relevant measurement results. In other words, according to the scheme of the present disclosure, users or experimenters may generate, according to relevant parameters of given quantum hardware and a topology structure, a control pulse that meets a given quantum task, to precisely control the quantum hardware, thereby achieving the given quantum task.

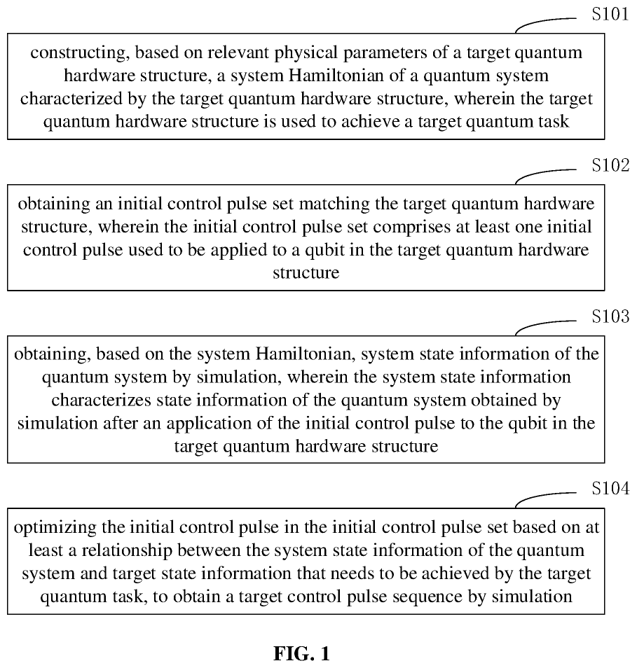

Specifically, FIG. 1 is a schematic flowchart showing an implementation of a quantum control pulse generation method according to an embodiment of the present disclosure. As shown in FIG. 1, the method includes:

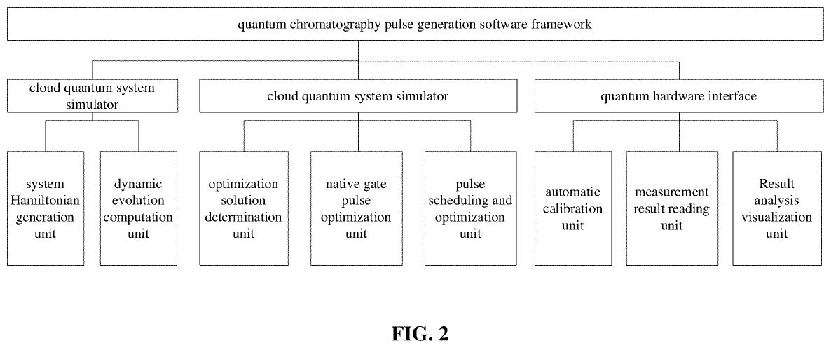

S101: constructing, based on relevant physical parameters of a target quantum hardware structure, a system Hamiltonian of a quantum system characterized by the target quantum hardware structure, wherein the target quantum hardware structure is used to achieve a target quantum task. In an example, as shown in FIG. 2, in a cloud quantum system simulator, a system Hamiltonian of a quantum system characterized by a target quantum hardware structure is constructed based on relevant physical parameters of a target quantum hardware structure. Further, in a system Hamiltonian generation unit of the cloud quantum system simulator shown in FIG. 2, relevant physical parameters of the target quantum hardware structure input by a user are received, and the system Hamiltonian of the quantum system characterized by the target quantum hardware structure is constructed based on the relevant physical parameters of the target quantum hardware structure. In actual applications, a cloud quantum system simulator is also used for a target quantum task input by a user that needs to be achieved. For example, in the system Hamiltonian generation unit shown in FIG. 2, the target quantum task input by the user that needs to be achieved is received.

S102: obtaining an initial control pulse set matching the target quantum hardware structure, wherein the initial control pulse set includes at least one initial control pulse used to be applied to a qubit in the target quantum hardware structure. In an example, as shown in FIG. 2, an initial control pulse set matching the target quantum hardware structure is obtained in a cloud quantum pulse optimizer. Further, in an optimization scheme determination unit of the cloud quantum pulse optimizer shown in FIG. 2, the initial control pulse set matching the target quantum hardware structure is obtained.

S103: obtaining, based on the system Hamiltonian, system state information of the quantum system by simulation, wherein the system state information characterizes state information of the quantum system obtained by simulation after an application of the initial control pulse to the qubit in the target quantum hardware structure. In an example, as shown in FIG. 2, in the cloud quantum system simulator, system state information of the quantum system is obtained by simulation based on the system Hamiltonian. Further, in a dynamic evolution computation unit of the cloud quantum system simulator shown in FIG. 2, system state information of the quantum system is obtained by simulation based on the system Hamiltonian. The state information of the quantum system herein may be specifically state information of respective qubits in the quantum system, such as a quantum state.

S104: optimizing the initial control pulse in the initial control pulse set based on at least a relationship between the system state information of the quantum system and target state information that needs to be achieved by the target quantum task, to obtain a target control pulse sequence by simulation, wherein the target quantum task can be achieved after the target control pulse sequence is applied to the qubit in the target quantum hardware structure. In an example, as shown in FIG. 2, in the cloud quantum pulse optimizer, the initial control pulse in the initial control pulse set is optimized based on at least the relationship between the system state information of the quantum system and the target state information that needs to be achieved in the target quantum task, to obtain a target control pulse sequence by simulation. The target quantum task can be achieved herein after the target control pulse sequence is applied to the qubit in the target quantum hardware structure.

According to the technique of the present disclosure, quantum computing software is combined with quantum computing hardware, that is, the quantum computing software is used to obtain a target control pulse sequence applied to a given quantum hardware structure, namely, a target quantum hardware structure. In this way, a given quantum task is achieved based on an obtained target control pulse sequence, that is, a target quantum task is achieved.

In a specific example of the scheme of the present disclosure, an initial control pulse set may also be obtained as follows: obtaining preset mapping relationship information, where the preset mapping relationship information characterizes a mapping relationship between relevant physical parameters of a quantum hardware structure and an optimal control pulse set. In this case, the obtaining an initial control pulse set matching the target quantum hardware structure as described above specifically includes: selecting, based on the preset mapping relationship information, an optimal control pulse set matching the relevant physical parameters of the target quantum hardware structure as an initial control pulse set matching the target quantum hardware structure. In this way, a foundation for achieving the target quantum task efficiently is laid.

In a specific example, in the cloud quantum pulse optimizer shown in FIG. 2, preset mapping relationship information is stored in advance, for example, an optimal pulse database of multiple quantum hardware structures is established in advance, and after the target quantum hardware structure is determined, the optimal control pulse set matching the relevant physical parameters of the target quantum hardware structure may be selected from the preset mapping information. Alternatively, the preset mapping relationship information is further stored in advance in the optimization scheme determination unit of the cloud quantum pulse optimizer. For example, an optimal pulse database of multiple quantum hardware structures is established in advance, and after the target quantum hardware structure is determined, the optimal control pulse set matching the relevant physical parameters of the target quantum hardware structure may be selected from the preset mapping information.

In a specific example of the scheme of the present disclosure, system state information of a quantum system may be obtained by simulation based on following methods. Specifically, the obtaining, based on the system Hamiltonian, the system state information of the quantum system by simulation described above includes: performing dynamic evolution processing on the system Hamiltonian based on the initial control pulse included in the initial control pulse set for being applied to the qubit in the target quantum hardware structure, to obtain the system state information of the quantum system by evolution. In other words, a dynamic evolution method may be used to obtain system state information of a quantum system by simulation. In this way, it provides quantifiable information for subsequent optimization of pulse parameters, thereby laying a foundation for improving the fidelity of a target control pulse sequence.

In an example, as shown in FIG. 2, in the cloud quantum system simulator, dynamic evolution processing is performed on the system Hamiltonian based on the initial control pulse included in the initial control pulse set for being applied to the qubit in the target quantum hardware structure, to obtain the system state information of the quantum system by evolution. Further, in the dynamic evolution computation unit of the cloud quantum system simulator, the dynamic evolution processing is performed on the system Hamiltonian based on the initial control pulse included in the initial control pulse set for being applied to the qubit in the target quantum hardware structure, to obtain the system state information of the quantum system by evolution.

In a specific example of the scheme of the present disclosure, following methods may be used to optimize an initial control pulse in an initial control pulse set. Specifically, a native quantum gate used for achieving a target quantum task is determined. The native quantum gate herein can be obtained through at least one qubit included in a target quantum hardware structure, and in other words, the native quantum gate can be realized by a target quantum hardware structure selected by a user. Further, the target quantum task is achieved based on the native quantum gate. Based on this, the above-mentioned optimizing the initial control pulse in the initial control pulse set based on at least a relationship between the system state information of the quantum system and target state information that needs to be achieved in the target quantum task specifically includes: optimizing the initial control pulse in the initial control pulse set in a case that it is determined the relationship between the system state information of the quantum system and the target state information that needs to be achieved in the target quantum task does not meet a preset task rule, to obtain an intermediate control pulse set, simulating a pulse control on the target quantum hardware structure based on an intermediate control pulse included in the intermediate control pulse set, to obtain an approximate native quantum gate by simulation, and achieving the target quantum task based on the approximate native quantum gate, wherein a fidelity of the approximate native quantum gate from the native quantum gate meets a preset fidelity rule. Here, the entire process is automated instead of manual or semi-automatic as in traditional laboratories, which simplifies operations of users or experimenters and improves user experience. Further, it also lays a foundation for improving the fidelity of a target control pulse sequence.

In this example, the intermediate control pulse is used to be applied to the qubit in the target quantum hardware structure by simulation. Further, the approximate native quantum gate can be obtained by simulation after the intermediate control pulse in the intermediate control pulse set is applied to the qubit in the target quantum hardware structure by simulation. The approximate native quantum gate is the quantum gate whose fidelity meets a preset fidelity requirement.

It should be noted that in actual applications, the number of native quantum gates and the type of quantum gates are related to a target quantum task.

In an example, as shown in FIG. 2, the native quantum gate used to achieve the target quantum task is determined in the cloud quantum pulse optimizer, to further optimize the initial control pulse in the initial control pulse set, so that the intermediate control pulse set can be obtained, in a case that it is determined the relationship between the system state information of the quantum system and the target state information that needs to be achieved in the target quantum task does not meet a preset task rule, that is, in a case that the initial control pulse set cannot achieve the target quantum task. It should be noted that the fidelity of an actual quantum gate obtained based on the current control pulse is simulated during the optimization process. In this way, an intermediate optimization pulse scheme is obtained by simulation, and the approximate native quantum gate is obtained by simulation.

It should be noted that there may be a plurality of native quantum gates corresponding to a quantum system, and a plurality of native quantum gates are required to achieve a target quantum task. At this time, the initial control pulse of the qubit forming the native quantum gate is optimized for each native quantum gate, so that after the optimized intermediate control pulse is applied to a corresponding qubit by simulation, the fidelity of the actually formed quantum gate meets the fidelity requirement (namely, the fidelity rule), that is, a difference between the actual quantum gate obtained by simulation and the corresponding native quantum gate is less than a preset threshold.

In a specific example of the scheme of the present disclosure, calibration may also be performed as follows: obtaining data characteristic information of a target quantum hardware device to be pulse-controlled, wherein the target quantum hardware device has the target quantum hardware structure; and performing data calibration on the intermediate control pulse included in the intermediate control pulse set, so that a calibrated intermediate control pulse matches the data characteristic information. In this way, various non-ideal factors of a quantum system are fully considered, and global optimization of a control pulse sequence is carried out. Furthermore, it is also automatically calibrated with a real quantum computer, so it is more practical.

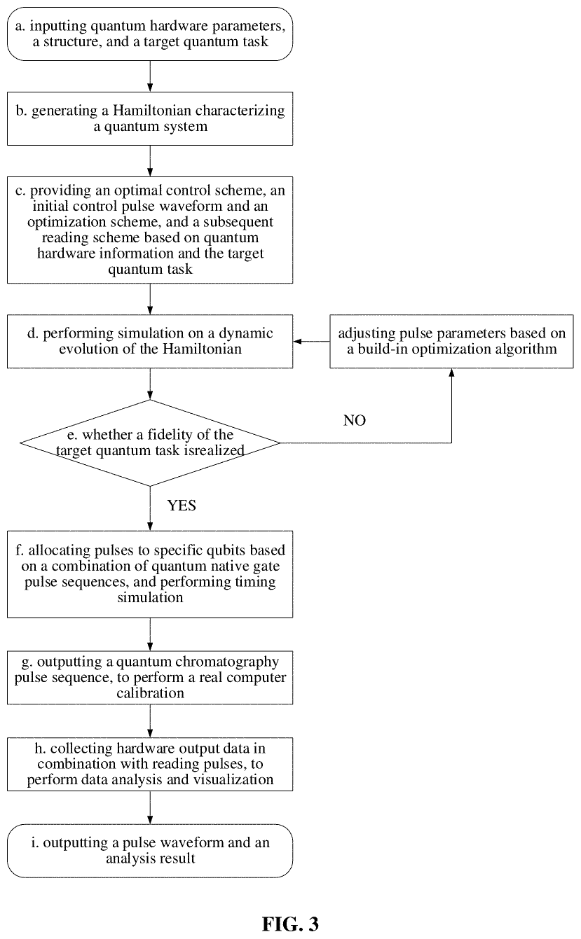

In a specific example, a calibration process is implemented in a quantum hardware interface shown in FIG. 3, namely, the quantum hardware interface is connected to a real quantum computer through a specific application program interface, and in turns the intermediate control pulse indicated by an intermediate optimization pulse scheme is taken as an input of a real target quantum hardware device to perform data calibration, to ensure that a calibrated pulse may properly control the real quantum computer. This further improves the practicability of the scheme of the present disclosure.

In a specific example of the scheme of the present disclosure, in a case that there are two or more native quantum gates, namely, there are two or more native quantum gates required to achieve a target quantum task, even if each approximate native quantum gate obtained based on the intermediate optimization pulse scheme meets the fidelity requirement, the obtained quantum gates may deviate from expected approximate native quantum gates due to problems such as crosstalk in a case that all the approximate native quantum gates are combined. Thus, the fidelity of obtained quantum gates will no longer meet the fidelity requirement. Based on this, it is necessary to further optimize the intermediate optimization pulse scheme. Specifically, the intermediate control pulse included in the intermediate control pulse set is optimized based on timing and/or order, to obtain the target control pulse sequence by simulation, where the approximate native quantum gate can be obtained based on the target control pulse included in the target control pulse sequence, to achieve the target quantum task. For example, the timing and/or order-based optimization processing is completed in the cloud quantum pulse optimizer, to further improve the fidelity of the obtained target control pulse sequence. It should be noted that the fidelity of an actual quantum gate obtained based on the current control pulse is also required to simulate during the optimization process. In this way, a target optimization pulse sequence is obtained by simulation.

Here, the target control pulse sequence includes two or more target control pulses applied to the qubit in the target quantum hardware device, and after the target control pulse is applied to the qubit in the target quantum hardware device, the target quantum task may be achieved.

In a specific example of the scheme of the present disclosure, following methods may also be used to verify or further optimize the obtained target control pulse sequence. Specifically, a measurement pulse, such as a chromatography pulse is obtained. The measurement pulse is applied after the target control pulse sequence is applied to a target quantum hardware device having the target quantum hardware structure, to obtain state information of respective qubits in the target quantum hardware device. The obtained state information of the respective qubits in the target quantum hardware device is quantum states of qubits obtained by a real device. In turns, the obtained state information of respective qubits in the target quantum hardware device is used to verify the target control pulse sequence for achieving the target quantum task, and/or the target control pulse sequence is further optimized based on a gap between the obtained real state information of qubits and the target state information. In this way, an automatic calibration process of the real quantum computer is realized to further improve the practicability of the scheme of the present disclosure.

In an example, through the quantum hardware interface shown in FIG. 2, the target control pulse sequence is applied to a target quantum hardware device having the target quantum hardware structure. Further, the measurement pulse is applied to obtain state information of respective qubits in the target quantum hardware device. Correspondingly, the cloud quantum system simulator may verify, by using the obtained state information of the respective qubits in the target quantum hardware device, the target control pulse sequence for achieving the target quantum task. After that, the cloud quantum pulse optimizer is called to further optimize the target control pulse sequence.

In a specific example of the scheme of the preset disclosure, a visual display may also be performed to facilitate browsing by users or experimenters. Specifically, at least the obtained state information of respective qubits in the target quantum hardware device is taken as an output result. The output result is displayed in a visual interactive interface. In actual applications, the quantum hardware interface may be used for visual display. Displayed content may be set based on user's requirements, for example, through a built-in visualization program, the target control pulse sequence, dynamic evolution of the quantum state, a quantum chromatography process, and other intermediate information or output results of the entire processing process are displayed in images for users to browse. In this way, user experience may be improved through a visual display method.

In combination with specific scenarios, the following further describes the scheme of the present disclosure in detail. Specifically, the scheme of the present disclosure provides a complete and automatic quantum control scheme that may be applied to a real quantum computer. Specifically, a software framework that is generated by the quantum control pulse sequence and that is based on a high-performance cloud quantum system simulator and a cloud quantum pulse optimizer is put forward. The control pulse sequence (namely, the target control pulse sequence) generated based on the software framework may be used to control the real quantum computer to achieve a given quantum task (namely, a quantum circuit, which is a logical quantum circuit). It focuses on a core module of the software framework and a process of using the software framework to generate the control pulse sequence for a specific quantum task (namely, the target quantum task) herein. Finally, an actual measurement effect on a real superconducting quantum computer will be displayed according to the scheme of the present disclosure to verify effectiveness and practicability of the scheme of the present disclosure. Specifically:

Part 1: The Software Framework that is Generated by the Quantum Control Pulse Sequence and that is Based on the High-Performance Cloud Quantum System Simulator and the Cloud Quantum Pulse Optimizer.

Quantum control herein is essentially to cause a quantum system to accurately evolve from an initial quantum state to a target quantum state by applying a physical pulse. There are several technical schemes for determining the quantum state of the quantum system experimentally, and a quantum chromatography method is adopted in the scheme of the present disclosure. The quantum chromatography in this example can reconstruct an unknown quantum state through experiment measurement data. For example, taking the simplest single qubit as an example, its quantum state may be characterized by a point in a Bloch sphere. To describe a quantum state completely, it is necessary to fully characterize its projection in X, Y, and Z directions. In the experiment, direct measurement can only characterize a component in the Z direction of the Bloch sphere. Further, for components in the X and Y directions, additional pulses need to be applied to the qubit, and the single qubit is rotated to the Z direction and for measurement, to completely describe state information of the qubit. Based on this, the scheme of the present disclosure can completely describe state information of each qubit in the quantum system.

The software framework in this example includes at least two core modules: i) a cloud quantum system simulator (also known as quantum system simulator, or simulator for short); ii) a cloud quantum pulse optimizer (also known as quantum pulse optimizer, or optimizer for short). To further improve the practicability of the software framework, a third core module, namely, iii) a quantum hardware interface may also be included.

It should be noted that in a case that a given quantum hardware structure includes a plurality of qubits, or a plurality of control pulses are required to achieve a target quantum task, a control pulse generated according to the scheme of the present disclosure may be expressed in the form of a control pulse sequence, to apply the pulse to the plurality of qubits in the quantum hardware structure based on the control pulse sequence, thereby achieving the target quantum task.

FIG. 2 is schematic structural diagram showing quantum computing software for implementing a quantum control pulse generation method according to an embodiment of the present disclosure. The following describes the three core modules in detail based on FIG. 2. Details of each module will be described in an experiment effect presentation part in combination with specific examples for a more detailed understanding.

Module 1, a cloud quantum system simulator, mainly includes two submodules: a system Hamiltonian generation unit and a dynamic evolution computation unit.

The system Hamiltonian generation unit is used to receive relevant physical parameters of a target quantum hardware structure input by a user, which may also be collectively referred to as quantum hardware information. A Hamiltonian of a quantum system corresponding to the target quantum hardware structure (namely, the system Hamiltonian) may be automatically constructed by judging the relevant physical parameters of the quantum hardware structure input by the user, which may be used as the basis for subsequent pulse optimization control.

A core function of the dynamic evolution computation unit is to perform dynamic evolution simulation based on the generated Hamiltonian of the quantum system, to determine whether the current control pulse can achieve the target quantum task. In this example, a built-in efficient algorithm may be used to perform dynamic evolution simulation on a time-dependent Hamiltonian. It is worth emphasizing that the program in this part may be configured on a cloud high-performance server to quickly compute dynamic evolution characteristics of the quantum system, thereby greatly improving the efficiency of the entire process.

Module 2, a cloud quantum pulse optimizer, mainly includes three submodules: an optimization scheme determination unit, a native gate pulse optimization unit, and a pulse scheduling optimization unit.

The optimization scheme determination unit establishes an optimal pulse database of a plurality of quantum hardware structures in advance, namely, establishes a mapping relationship between the relevant physical parameters of the quantum hardware structure and the optimal control pulse set, and establishes, according to quantum hardware information input by the user, an initial pulse optimization scheme matching the input quantum hardware information (namely, the initial control pulse set). The initial pulse optimization scheme is that the initial pulse optimization set includes at least one initial control pulse. Specifically, the information indicated by the initial control pulse includes, but is not limited to selection of a control channel for the qubit, selection of a pulse waveform, and the like. The control channel is a channel for applying the control pulse. In actual applications, there will be a plurality of control channels for the qubit, such as channels X, Y, and Z. The control pulse may be applied to any of the channels: X, Y, and Z. In this way, the qubit is controlled, and in turns, the quantum system is controlled. For ease of description, the initial control pulse in this example is one-to-one corresponding to the qubit, namely, the information indicated by the initial control pulse can characterize a mapping relationship between the qubit, the applying channel, the pulse waveform, and the like.

The native gate pulse optimization unit is configured to develop a pulse optimization design for each native quantum gate of the quantum system (the native quantum gate refers to a quantum gate that is easier to implement under a specific quantum hardware structure, such as an X gate in superconducting quantum computing, a Controlled-phase gate, a Cross-resonance gate, and an iSWAP gate) according to the obtained initial pulse optimization scheme, such as optimizing the selected pulse waveform, to optimize the initial pulse optimization scheme, thereby constructing a native quantum gate with high fidelity. In this step, a pulse scheme obtained by optimizing the initial pulse optimization scheme may be referred to as an intermediate optimization pulse scheme (namely, the intermediate control pulse set). The intermediate optimization pulse scheme is that the intermediate control pulse set includes a plurality of intermediate control pulses.

It should be noted that there may be a plurality of native quantum gates corresponding to a quantum system, and a plurality of native quantum gates are required to achieve a target quantum task. At this time, the initial control pulse of the qubit forming the native quantum gate is optimized for each native quantum gate, so that after the optimized intermediate control pulse is applied to a corresponding qubit by simulation, the fidelity of the actually formed quantum gate meets the fidelity requirement (namely, the fidelity rule), that is, a difference between the actual quantum gate obtained by simulation and the corresponding native quantum gate is less than a preset threshold. In this example, the actual quantum gate obtained by simulation based on the intermediate control pulse is referred to as an approximate native quantum gate, and the approximate native quantum gate is a high-fidelity native quantum gate.

In actual applications, in a case that there are a plurality of native quantum gates, even if each approximate native quantum gate obtained based on the intermediate optimization pulse scheme meets the fidelity requirement, the obtained quantum gates may deviate from expected approximate native quantum gates due to problems such as crosstalk in a case that all the approximate native quantum gates are combined. Thus, the fidelity of obtained quantum gates will no longer meet the fidelity requirement. Based on this, it is necessary to further optimize the intermediate optimization pulse scheme by using a pulse scheduling and optimization unit.

It should be noted that the fidelity of the actual quantum gate obtained based on the current control pulse is simulated by a scheduling dynamic evolution computation unit during the optimization process. In this way, the intermediate optimization pulse scheme is obtained by simulation, and the approximate native quantum gate is obtained by simulation.

The pulse scheduling optimization unit combines, according to a target quantum task input by a user, native quantum gates in a quantum system for achieving the target quantum task, and determines a pulse scheduling mode based on the intermediate optimization pulse scheme, for example, determining action timing and action order of each intermediate control pulse to obtain the target control pulse sequence by simulation. The target control pulse sequence includes action timing and action order of each target control pulse. The target control pulse herein is obtained based on the intermediate control pulse. For example, in a case that there is no need to optimize the intermediate control pulse, the intermediate control pulse is directly used as the target control pulse, and in a case that the intermediate control pulse needs to be optimized, the intermediate control pulse is optimized to obtain the target control pulse. In other words, in actual applications, the pulse scheduling optimization unit not only implements order or timing scheduling, but also optimizes other parameters in the intermediate control pulse, to obtain the target control pulse sequence.

Further, the fidelity of an actual quantum task obtained based on a target control pulse sequence by simulation should meet a preset task requirement (also referred to as a preset task rule), for example, an actual quantum task obtained based on a target control pulse sequence by simulation has the highest fidelity.

In addition, a target control pulse sequence obtained through optimization simulation may also be buffered for rapid calling of pulses in subsequent quantum chromatography tasks.

It should be pointed out that the pulse scheduling optimization unit also needs to call the dynamic evolution computation unit to perform dynamics simulation on a control pulse sequence obtained after scheduling to ensure that it is an optimal pulse sequence, and in turns, the target control pulse sequence is obtained by simulation. In actual applications, the target control pulse sequence obtained after optimization may be used as an input pulse on a real quantum computer (namely, a real target quantum hardware device with the target quantum hardware structure) for verification.

Module 3, a quantum hardware interface, mainly includes three submodules: an automatic calibration unit, a measurement result reading unit, and a result analysis visualization unit.

The automatic calibration unit is connected to a real quantum computer through a specific application program interface, for example, connected to a real target quantum hardware device with a target quantum hardware structure, and taking the intermediate control pulse indicated by the intermediate optimization pulse scheme obtained by the native gate pulse optimization unit as input of the real target quantum hardware device to calibrate the intermediate optimization pulse scheme, or taking the intermediate control pulse indicated by the intermediate optimization pulse scheme obtained by the native gate pulse optimization unit and the target control pulse sequence obtained by the pulse scheduling optimization unit as the input of the real target quantum hardware device, to calibrate the intermediate optimization pulse scheme and the target control pulse sequence. The calibration herein may be accuracy calibration and the like, to ensure that the pulse obtained after calibration may properly control the real quantum computer.

It should be noted that in an actual calibration process, to ensure effective control, the intermediate optimization pulse scheme must be calibrated, and the calibrated intermediate optimization pulse scheme is sent to the pulse scheduling optimization unit for scheduling optimization. At this time, the target control pulse sequence obtained through scheduling optimization by the pulse scheduling optimization unit may not need to be calibrated. Alternatively, after the intermediate optimization pulse scheme is calibrated, it may be further determined based on the target quantum task whether it is necessary to further calibrate the target control pulse sequence obtained by the pulse scheduling optimization unit.

The measurement result reading unit is mainly configured to: after applying the optimized target control pulse sequence to the real target quantum hardware device with the target quantum hardware structure, measure state information of each qubit in the target quantum hardware device. For example, a quantum chromatography method may be used to measure the state information of each qubit in the target quantum hardware device. Specifically, a measurement pulse required for quantum chromatography is designed according to the relevant physical parameters of the quantum hardware structure input by a user, such as a chromatography pulse and a reading pulse, and acting on a real target quantum hardware device after being acted on the target control pulse sequence, to fit a pulse signal returned by the target quantum hardware device, and prepare a quantum state and correct a measurement error matrix, to obtain the state information of each qubit in the target quantum hardware device. Further, the state information of each qubit in the target quantum hardware device may be taken as an output result, and be output to the user.

The result analysis visualization unit provides, according to the target quantum task and the output result of the measurement result reading unit, information such as fidelities of the obtained actual quantum task and the target quantum task, error distribution of the obtained approximate native quantum gate, and dynamic evolution of the quantum system. Further, through a built-in visualization program, the target control pulse sequence, dynamic evolution of the quantum state, a quantum chromatography process, and other intermediate information or output results of the entire processing process are displayed in images for users to browse.

Further, a quantum control pulse sequence generation process, namely, a target control pulse sequence generation process for a specific quantum task (namely, a target quantum task) is described in detail based on the foregoing three core modules. To understand specific meaning of each process node more clearly, it will be described in detail in the experiment effect presentation part in combination with specific examples. As shown in FIG. 3, specific steps include:

Step 1: A user enters relevant physical parameters of a target quantum hardware structure (namely, quantum hardware parameters and structure, which may be collectively referred to as quantum hardware information) through a visual interface or an application software interface in a high-level programming language, and the target quantum task required to be achieved.

Step 2: A cloud quantum system simulator automatically generates the system Hamiltonian of the quantum system matching the target quantum hardware structure based on the relevant physical parameters of the target quantum hardware structure input by the user, and transmits it to a dynamic evolution computation unit of the cloud quantum system simulator, so that the dynamic evolution computation unit may perform dynamic evolution simulation and assist in completing the pulse optimization process.

Step 3: The cloud quantum pulse optimizer may determine the initial pulse optimization scheme (namely, the optimal control scheme shown in FIG. 2) according to the quantum hardware information input by the user and the target quantum task, including which native quantum gate that can be realized by the target quantum hardware structure, the selected pulse waveform, which channel of which qubit in the target quantum hardware structure to which the pulse is applied, and the like.

Step 4: The dynamic evolution computation unit in the cloud quantum system simulator is called based on the initial pulse optimization scheme determined in step 3, and the system Hamiltonian is combined with, to perform the dynamic evolution simulation, so that a calculation result is obtained.

Step 5: It is determined whether the actual quantum gate that is obtained by simulation and that is characterized by the calculation result meets the fidelity requirement, for example, whether the difference between the actual quantum gate obtained by simulation and the native quantum gate to be realized is less than a preset threshold. If not, the native gate pulse optimization unit in the cloud quantum pulse optimizer adjusts, based on a built-in optimization algorithm, the pulse parameters of the initial control pulse that does not meet the requirement in the initial pulse optimization scheme, and re-executes dynamic evolution simulation until the actual quantum gate meets the fidelity requirement. At this time, the actual quantum gate that meets the fidelity requirement may be referred to as the approximate native quantum gate. In this way, each initial control pulse in the initial pulse optimization scheme is optimized, to obtain the intermediate optimization pulse scheme (namely, combination of the native gate pulse sequences shown in FIG. 2).

Step 6: After the intermediate optimization pulse scheme is obtained, the pulse scheduling optimization unit combines the native quantum gates of the quantum system based on the target quantum task, and determines the pulse scheduling method based on the intermediate optimization pulse scheme. For example, action timing and action order of each intermediate control pulse are determined, to obtain the target control pulse sequence (namely, the quantum chromatography pulse sequence shown in FIG. 2). The target control pulse sequence includes action timing and action order of each target control pulse. In an actual process, the obtained intermediate optimization pulse scheme is allocated to each specific qubit of the target quantum hardware structure by simulation, and timing simulation and/or order simulation are performed to obtain the target control pulse sequence by simulation.

Step 7: The target control pulse sequence is taken as input, and is input into the real target quantum hardware device, to perform calibration. In an actual process, the automatic calibration unit is configured to calibrate the intermediate optimization pulse scheme generated by the native gate pulse optimization unit on the real target quantum hardware device. Further, a calibration of a finally obtained target control pulse sequence is performed on the real target quantum hardware device. The calibrated pulse sequence is used as a pulse sequence finally input into the real target quantum hardware device.

Step 8: In combination with the measurement pulse, including a reading pulse and a chromatography pulse, the real target quantum hardware device to which the pulse sequence calibrated in step 7 is applied, is measured, to determine status information of each qubit in the real target quantum hardware device. In actual applications, a quantum state density matrix describing the target quantum hardware device may be constructed according to results corresponding to different quantum chromatography pulses, to further complete the calibration process.

Step 9: Real output data of the target quantum hardware device, such as the state information of each qubit in the target quantum hardware structure is taken as the output result, and a visual display is performed. The result analysis visualization unit herein may be used to display the output data obtained above.

The foregoing process describes the entire process of generating the control pulse required for a specific quantum task according to the scheme of the present disclosure. To present core modules and key processes of the scheme of the present disclosure more specifically, and to understand each module and specific steps in detail, the following uses a specific example for further explanation.

Part 2: Present Experimental Effects.

To better present the effectiveness and practicability of the scheme of the present disclosure, and to elaborate on each core module and key step of the scheme of the present disclosure in detail, in this part, the scheme of the present disclosure is actually performed on a real superconducting quantum computer including a qubit.

Specifically, relevant physical parameters of a quantum hardware structure, namely, relevant physical parameters of a real superconducting quantum computer including a qubit, such as frequency and detuning intensity of the qubit, and a target quantum task (the task herein is to realize a single qubit Hadamard gate and an X gate respectively) are input into the cloud quantum system simulator shown in FIG. 2, and the system Hamiltonian generation unit is used to automatically generate a system Hamiltonian describing the quantum system characterized by the quantum hardware structure. Moreover, the cloud quantum pulse optimizer may simulate the target control pulse sequence according to the target quantum task and the quantum hardware structure. Specifically, the intermediate optimization pulse scheme of the native quantum gate (including an X gate, a Y gate, and a Z gate) that can be realized by the quantum system is determined firstly, which is realized by the native gate pulse optimization unit. Secondly, scheduling optimization is performed on the intermediate optimization pulse scheme based on the pulse scheduling and optimization unit, to obtain the target control pulse sequence by simulation. Finally, chromatography measurement and analysis are performed on an optimization pulse (namely, the target control pulse sequence). Based on this, two types of pulses are prepared: the first is the target control pulse sequence to be tested, namely, the target control pulse sequence used herein to realize the Hadamard gate and the X gate; the second is the measurement pulse used for quantum chromatography, including a chromatography pulse, a reading pulse, and the like. The chromatography pulse and the reading pulse are required to be combined with the target control pulse sequence to be tested, and are input into the real superconducting quantum computer (namely, the real quantum hardware device with the quantum hardware structure input by a user) after timing design and scheduling optimization.

In this actual case, only a real superconducting quantum computer with one qubit is connected, so it is only necessary to schedule the target control pulse sequence to be tested before the chromatography pulse and the reading pulse. In actual applications, the qubit is constantly initialized and placed in a ground state, to which the target control pulse sequence required to be measured is applied then, and quantum chromatography is performed on a pulse-acted quantum state. After the target control pulse sequence to be tested is applied, pulses corresponding to the X gate, the Y gate, the Z gate, and the I gate are applied in turns, and state information of the qubit is read (for example, along a Z direction), and the density matrix of the qubit is reconstructed according to the measurement result. In this way, the target control pulse sequence is verified. It should be particularly pointed out that the chromatography pulse used in quantum chromatography may be generated by the foregoing native gate pulse optimization unit, and then calibrated by the automatic calibration unit, and finally enter the pulse scheduling and optimization unit.

As mentioned above, the goal herein is to realize a control pulse of the Hadamard gate (namely, H gate) and the X gate, so that the control pulse may achieve a benchmark test of a real superconducting quantum computer. Specifically, as a commonly used quantum gate in quantum computing, H gate may transform

$$\vert 0 〉 to \frac{\vert 0 〉 + \vert 1 〉}{\sqrt{2}} ,$$

and transform

$$\vert 1 〉 to \frac{\vert 0 〉 - \vert 1 〉}{\sqrt{2}} ,$$

which may be expressed in a matrix:

$$H = \frac{1}{\sqrt{2}} [ \begin{matrix}1 & 1 \\ 1 & - 1\end{matrix} ] ;$$

The X gate may realize flip of the quantum state, transforming |0 [symbol] to |1 [symbol] , and transforming |1 [symbol] to |0 [symbol] , which may be expressed in a matrix:

$$X = [ \begin{matrix}0 & 1 \\ 1 & 0\end{matrix} ] ,$$

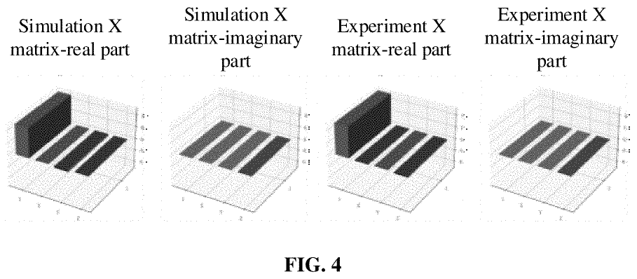

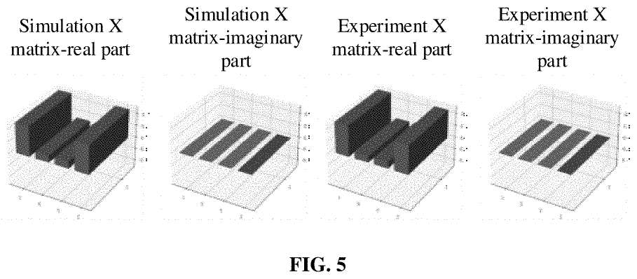

to fully verify the validity of the scheme of the present disclosure. In other words, after the foregoing target control pulse sequence is applied to a real superconducting quantum computer, the target control pulse sequence obtained according to the scheme of the present disclosure for realizing the target quantum task is verified by reading the measurement result of the real superconducting quantum computer. Specifically, in this example, the density matrix (the density matrix may be used to describe quantum state of an open system) obtained through quantum chromatography is used as a measurement standard. Specifically, a theoretical density matrix (corresponding to the simulation x matrix shown in FIG. 4 and FIG. 5) of the target control pulse sequence is obtained based on the cloud quantum system simulator, the obtained density matrix (corresponding to an experiment χ matrix shown in FIG. 4 and FIG. 5) is reconstructed through experiment measurement, and χ matrix factorization is performed on the result, namely, rewriting a density matrix as a linear combination of Pauli matrices, such as ρ=a₁I+a₂X+a₃Y+a₄Z. A real part and an imaginary part of coefficients a₁ (i=1,2,3,4) are plotted as a three-dimensional histogram respectively, as shown in FIG. 4 and FIG. 5. In density matrix chromatograms shown in FIG. 4 and FIG. 5, a horizontal coordinate is corresponding to different Pauli matrices (namely, X, Y, Z, and I), and a vertical coordinate is corresponding to expansion coefficientsaᵢ. Each chromatogram includes a real part and an imaginary part. Two diagrams on the left are corresponding to chromatograms corresponding to ideal results of theoretical simulation, and two diagrams on the right are corresponding to chromatograms of the density matrix obtained through experiment measurement and analysis of the real quantum computer. It can be seen from FIG. 4 (corresponding to the Hadamard gate) and FIG. 5 (corresponding to the X gate) that an experiment result obtained by inputting the target control pulse sequence generated in the scheme of the present disclosure into the real quantum computer is almost consistent with a theoretical simulation result. To be more specific, by calculating a distance between a simulation result and a density matrix corresponding to the experiment result based on the scheme of the present disclosure, namely, D(ρ, σ)=Tr|ρ−σ|/2, D=0.020857 for the Hadamard gate is obtained. In the same way, a distance D=0.02168 is obtained for the X gate. It fully shows that the two are extremely similar with each other. It can be concluded that the target control pulse sequence and measurement pulse generated in the scheme of the present disclosure may be used to effectively analyze the actual state of the quantum system, which fully verifies the effectiveness of the scheme of the present disclosure.

In conclusion, compared with other quantum control (or pulse generation) technical schemes in the industry, the scheme of the present disclosure has significant advantages in the following aspects:

Compared with the existing traditional schemes, the scheme of the present disclosure is more practical in terms of practicability, because various non-ideal factors of the quantum system are fully considered in the scheme of the present disclosure, and global optimization of the control pulse sequence is carried out. Furthermore, it is also automatically calibrated with the real quantum computer, so it is more practical.

Compared with the existing traditional schemes, the scheme of the present disclosure is superior in terms of automation. The reason is that the control pulse sequence generation software framework of the scheme of the present disclosure may automatically start corresponding modules to generate pulses that may be recognized by quantum hardware, to achieve a given quantum task. The entire process is automated instead of manual or semi-automatic as in traditional laboratories, which simplifies operations of users or experimenters and improves user experience.

A wide hardware applicable range. The reason is that the scheme of the present disclosure is a universal framework method of dynamic evolution simulation based on the system Hamiltonian. It can simulate different quantum hardware systems and generate corresponding control pulses to control real quantum computers. Furthermore, the scheme of the present disclosure is not only suitable for superconducting circuits, but also effective for quantum hardware platforms, such as ion trap and nuclear magnetic resonance.

Strong scalability. The reason is that in the scheme of the present disclosure, users are allowed to develop new pulse optimization and scheduling schemes according to their own needs, generate corresponding computing pulses based on a cloud high-performance server, and achieve a required optimization effect, which broadens an application scope of the software framework. In addition, users may also perform custom visualization operations based on returned data to output specific data visualization according to their own needs, thereby meeting requirements of different users and improving user experience.

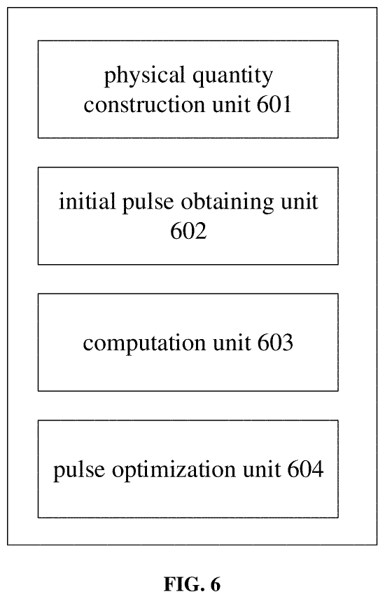

According to the scheme of the present disclosure, as shown in FIG. 6, it is also provided a quantum control pulse generation apparatus, including:

a physical quantity construction unit 601, configured for constructing, based on relevant physical parameters of a target quantum hardware structure, a system Hamiltonian of a quantum system characterized by the target quantum hardware structure, wherein the target quantum hardware structure is used to achieve a target quantum task;

an initial pulse obtaining unit 602, configured for obtaining an initial control pulse set matching the target quantum hardware structure, wherein the initial control pulse set includes at least one initial control pulse used to be applied to a qubit in the target quantum hardware structure;

a computation unit 603, configured for obtaining, based on the system Hamiltonian, system state information of the quantum system by simulation, wherein the system state information characterizes state information of the quantum system obtained by simulation after an application of the initial control pulse to the qubit in the target quantum hardware structure; and

a pulse optimization unit 604, configured for optimizing the initial control pulse in the initial control pulse set based on at least a relationship between the system state information of the quantum system and target state information that needs to be achieved by the target quantum task, to obtain a target control pulse sequence by simulation, wherein the target quantum task can be achieved after the target control pulse sequence is applied to the qubit in the target quantum hardware structure.

In a specific example of the scheme of the present disclosure, the apparatus further includes a mapping relationship obtaining unit, wherein

the mapping relationship obtaining unit is configured for obtaining preset mapping relationship information, wherein the preset mapping relationship information characterizes a mapping relationship between relevant physical parameters of a quantum hardware structure and an optimal control pulse set; and

the initial pulse obtaining unit is further configured for selecting, based on the preset mapping relationship information, an optimal control pulse set matching the relevant physical parameters of the target quantum hardware structure as the initial control pulse set matching the target quantum hardware structure.

In a specific example of the scheme of the present disclosure, the computation unit is further configured for performing dynamic evolution processing on the system Hamiltonian based on the initial control pulse included in the initial control pulse set for being applied to the qubit in the target quantum hardware structure, to obtain the system state information of the quantum system by evolution.

In a specific example of the scheme of the present disclosure, the apparatus further includes a native gate determination unit, wherein

the native gate determination unit is configured for determining a native quantum gate for achieving the target quantum task, wherein the native quantum gate can be obtained from at least one qubit included in the target quantum hardware structure; and

the pulse optimization unit is further configured for optimizing the initial control pulse in the initial control pulse set in a case that it is determined the relationship between the system state information of the quantum system and the target state information that needs to be achieved in the target quantum task does not meet a preset task rule, to obtain an intermediate control pulse set, simulating a pulse control on the target quantum hardware structure based on an intermediate control pulse included in the intermediate control pulse set, to obtain an approximate native quantum gate by simulation, and achieving the target quantum task based on the approximate native quantum gate, wherein a fidelity of the approximate native quantum gate from the native quantum gate meets a preset fidelity rule.

In a specific example of the scheme of the present disclosure, the apparatus further includes:

a data calibration unit, configured for obtaining data characteristic information of a target quantum hardware device to be pulse-controlled, wherein the target quantum hardware device has the target quantum hardware structure; performing data calibration on the intermediate control pulse included in the intermediate control pulse set, so that a calibrated intermediate control pulse matches the data characteristic information.

In a specific example of the scheme of the present disclosure, the pulse optimization unit is further configured for performing a timing and/or order-based optimization processing on the intermediate control pulse included in the intermediate control pulse set in a case that there exist two or more native quantum gates, to obtain the target control pulse sequence by simulation, wherein the approximate native quantum gate can be obtained based on the target control pulse included in the target control pulse sequence, to achieve the target quantum task.

In a specific example of the scheme of the present disclosure, the apparatus further includes:

a verification unit, configured for obtaining a measurement pulse; applying the measurement pulse after applying the target control pulse sequence to a target quantum hardware device having the target quantum hardware structure, to obtain state information of respective qubits in the target quantum hardware device; and verifying and/or optimizing, by using obtained state information of the respective qubits in the target quantum hardware device, the target control pulse sequence for achieving the target quantum task.

In a specific example of the scheme of the present disclosure, the apparatus further includes:

a visualization unit, configured for taking at least the obtained state information of the respective qubits in the target quantum hardware device as an output result; and displaying the output result in a visual interactive interface.

The functions of respective units of the quantum control pulse generation apparatus according to embodiments of the present disclosure can be referred to corresponding descriptions of the above-described method, which will not be repeated in detail here.

According to an embodiment of the present disclosure, the present disclosure also provides an electronic device, a readable storage medium, and a computer program product.

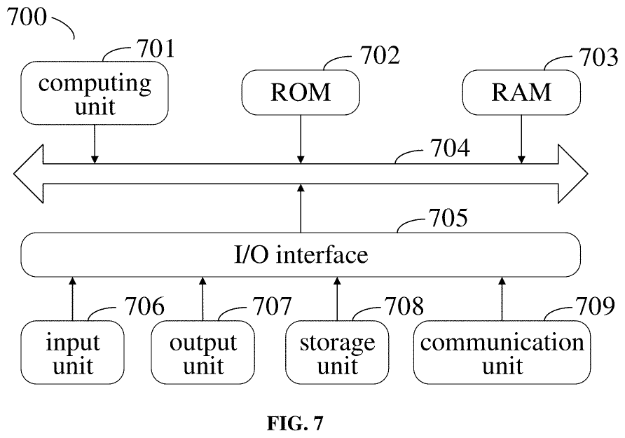

FIG. 7 is a schematic block diagram of an electronic device 700 for implementing a quantum control pulse generation method according to an embodiment of the present disclosure. The electronic device is intended to represent various forms of digital computers, such as laptop computers, desktop computers, workbenches, personal digital assistants, servers, blade servers, mainframe computers, and other suitable computers. Electronic apparatuses may also represent various forms of mobile devices, such as personal digital assistants, cellular phones, smart phones, wearable devices, and other similar computing devices. The components shown herein, their connections and relationships, and their functions are merely examples, and are not intended to limit the implementation of the present disclosure described and/or claimed herein.

As shown in FIG. 7, the electronic device 700 includes a computing unit 701 that may perform various suitable actions and processes in accordance with a computer program stored in a read only memory (ROM) 702 or a computer program loaded from a storage unit 708 into a random-access memory (RAM) 703. In the RAM 703, various programs and data required for the operation of the storage apparatus 700 can also be stored. The computing unit 701, the ROM 702 and the RAM 703 are connected to each other through a bus 704. An input/output (I/O) interface 705 is also connected to the bus 704.

A number of components in the electronic device 700 are connected to the I/O interface 705, including an input unit 706, such as a keyboard, a mouse; an output unit 707, such as various types of displays, speakers; a storage unit 708, such as a magnetic disk, an optical disk; and a communication unit 709, such as a network card, a modem, a wireless communication transceiver. The communication unit 709 allows the apparatus 700 to exchange information/data with other apparatuses over a computer network, such as the Internet, and/or various telecommunication networks.

The computing unit 701 may be various general purpose and/or special purpose processing components having processing and computing capabilities. Some examples of the computing unit 701 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 701 performs various methods and processes described above, such as a quantum control pulse generation method. For example, in some embodiments, the quantum control pulse generation method may be implemented as a computer software program tangibly contained in a machine-readable medium, such as the storage unit 708. In some embodiments, some or all of computer programs may be loaded into and/or installed on the apparatus 700 via a ROM 702 and/or a communication unit 709. When a computer program is loaded into the RAM 703 and executed by the computing unit 701, one or more steps of the quantum control pulse generation method described above may be performed. Alternatively, in other embodiments, the computing unit 701 may be configured to perform the quantum control pulse generation method by any other suitable means (e.g., via a firmware).

Various implementation modes of the system and technology described above herein may be implemented in a digital electronic circuit system, an integrated circuit system, a field programmable gate array (FPGA), an application specific integrated circuit (ASIC), an application specific standard product (ASSP), a system on chip system (SOC), a load programmable logic device (CPLD), computer hardware, firmware, software, and/or a combination thereof. These various implementation modes may include: implementing in one or more computer programs, which can be executed and/or interpreted on a programmable system including at least one programmable processor. The programmable processor can be a dedicated or general-purpose programmable processor, which can receive data and instructions from, and transmit the data and instructions to, a memory system, at least one input device, and at least one output device.

Program codes for implementing methods of the present disclosure may be written in any combination of one or more programming languages. These program codes may be provided to a processor or a controller of a general-purpose computer, a special purpose computer, or other programmable data processing units, such that program codes, when executed by the processor or the controller, cause functions/operations specified in a flowchart and/or a block diagram to be performed. The program codes may be executed entirely on a machine, partly on a machine, partly on a machine as a stand-alone software package and partly on a remote machine, or entirely on a remote machine or a server.

In the context of the present disclosure, a machine-readable medium can be a tangible medium that may contain or store a program for use by or in connection with an instruction execution system, device, or apparatus. The machine-readable medium may be a machine-readable signal medium or a machine-readable storage medium. The machine-readable medium may include, but is not limited to, electronic, magnetic, optical, electromagnetic, infrared, or semi-conductive systems, devices, or apparatuses, or any suitable combination thereof. More specific examples of the machine-readable storage medium may include one or more wire-based electrical connections, a portable computer diskette, a hard disk, a random-access memory (RAM), a read-only memory (ROM), an erasable programmable read-only memory (EPROM or Flash memory), an optical fiber, a portable compact disk read-only memory (CD-ROM), an optical storage apparatus, a magnetic storage apparatus, or any suitable combination thereof.

In order to provide interactions with a user, the system and technology described herein may be implemented on a computer having a display device (for example, a cathode ray tube (CRT) or a liquid crystal display (LCD) monitor) for displaying information to the user; and a keyboard and pointing device (e.g., a mouse or a trackball) through which a user can provide input to the computer. Other types of devices may also be used to provide an interaction with a user. For example, the feedback provided to a user may be any form of sensory feedback (e.g., visual feedback, auditory feedback, or tactile feedback); and the inputs from a user may be received in any form, including acoustic input, voice input, or tactile input.

The systems and techniques described herein may be implemented in a computing system (for example, as a data server) that includes back-end components, or be implemented in a computing system (for example, an application server) that includes middleware components, or be implemented in a computing system (for example, a user computer with a graphical user interface or a web browser through which the user may interact with the implementation of the systems and technologies described herein) that includes front-end components, or be implemented in a computing system that includes any combination of such back-end components, intermediate components, or front-end components. The components of the system may be interconnected by any form or medium of digital data communication (for example, a communication network). Examples of communication networks include: a Local Area Network (LAN), a Wide Area Network (WAN), the Internet.

The computer system may include a client and a server. The client and the server are generally remote from each other and typically interact through a communication network. The client-server relationship is generated by computer programs that run on respective computers and have a client-server relationship with each other.

It should be understood that various forms of processes shown above may be used to reorder, add, or delete steps. For example, respective steps described in the present disclosure may be executed in parallel, or may be executed sequentially, or may be executed in a different order, as long as the desired result of the technical scheme disclosed in the present disclosure can be achieved, to which no limitation is made herein.

The above specific embodiments do not constitute a limitation on the protection scope of the present disclosure. It should be understood by those skilled in the art that various modifications, combinations, sub-combinations, and substitutions may be made according to design requirements and other factors. Any modification, equivalent replacement and improvement, and the like made within the spirit and principle of the present disclosure shall be fall in the protection scope of the present disclosure.

What is claimed is:

1. A quantum control pulse generation method, comprising:
constructing, based on relevant physical parameters of a target quantum hardware structure, a system Hamiltonian of a quantum system characterized by the target quantum hardware structure, wherein the target quantum hardware structure is used to achieve a target quantum task;
obtaining an initial control pulse set matching the target quantum hardware structure, wherein the initial control pulse set comprises at least one initial control pulse used to be applied to a qubit in the target quantum hardware structure;
obtaining, based on the system Hamiltonian, system state information of the quantum system by simulation, wherein the system state information characterizes state information of the quantum system obtained by simulation after an application of the initial control pulse to the qubit in the target quantum hardware structure; and
optimizing the initial control pulse in the initial control pulse set based on at least a relationship between the system state information of the quantum system and target state information that needs to be achieved by the target quantum task, to obtain a target control pulse sequence by simulation, wherein the target quantum task can be achieved after the target control pulse sequence is applied to the qubit in the target quantum hardware structure.

2. The quantum control pulse generation method according to claim 1, further comprising:
obtaining preset mapping relationship information, wherein the preset mapping relationship information characterizes a mapping relationship between relevant physical parameters of a quantum hardware structure and an optimal control pulse set; wherein
the obtaining the initial control pulse set matching the target quantum hardware structure comprises:
selecting, based on the preset mapping relationship information, an optimal control pulse set matching the relevant physical parameters of the target quantum hardware structure as the initial control pulse set matching the target quantum hardware structure.

3. The quantum control pulse generation method according to claim 1, wherein the obtaining, based on the system Hamiltonian, the system state information of the quantum system by simulation comprises:
performing dynamic evolution processing on the system Hamiltonian based on the initial control pulse comprised in the initial control pulse set for being applied to the qubit in the target quantum hardware structure, to obtain the system state information of the quantum system by evolution.

4. The quantum control pulse generation method according to claim 1, further comprising:
determining a native quantum gate for achieving the target quantum task, wherein the native quantum gate can be obtained from at least one qubit comprised in the target quantum hardware structure; wherein
the optimizing the initial control pulse in the initial control pulse set based on at least the relationship between the system state information of the quantum system and the target state information that needs to be achieved in the target quantum task comprises:
optimizing the initial control pulse in the initial control pulse set in a case that it is determined the relationship between the system state information of the quantum system and the target state information that needs to be achieved in the target quantum task does not meet a preset task rule, to obtain an intermediate control pulse set, simulating a pulse control on the target quantum hardware structure based on an intermediate control pulse comprised in the intermediate control pulse set, to obtain an approximate native quantum gate by simulation, and achieving the target quantum task based on the approximate native quantum gate, wherein a fidelity of the approximate native quantum gate from the native quantum gate meets a preset fidelity rule.

5. The quantum control pulse generation method according to claim 3, further comprising:
determining a native quantum gate for achieving the target quantum task, wherein the native quantum gate can be obtained from at least one qubit comprised in the target quantum hardware structure; wherein
the optimizing the initial control pulse in the initial control pulse set based on at least the relationship between the system state information of the quantum system and the target state information that needs to be achieved in the target quantum task comprises:
optimizing the initial control pulse in the initial control pulse set in a case that it is determined the relationship between the system state information of the quantum system and the target state information that needs to be achieved in the target quantum task does not meet a preset task rule, to obtain an intermediate control pulse set, simulating a pulse control on the target quantum hardware structure based on an intermediate control pulse comprised in the intermediate control pulse set, to obtain an approximate native quantum gate by simulation, and achieving the target quantum task based on the approximate native quantum gate, wherein a fidelity of the approximate native quantum gate from the native quantum gate meets a preset fidelity rule.

6. The quantum control pulse generation method according to claim 4, further comprising:
obtaining data characteristic information of a target quantum hardware device to be pulse-controlled, wherein the target quantum hardware device has the target quantum hardware structure; and
performing data calibration on the intermediate control pulse comprised in the intermediate control pulse set, so that a calibrated intermediate control pulse matches the data characteristic information.

7. The quantum control pulse generation method according to claim 4, further comprising:
performing a timing and/or order-based optimization processing on the intermediate control pulse comprised in the intermediate control pulse set in a case that there exist two or more native quantum gates, to obtain the target control pulse sequence by simulation, wherein the approximate native quantum gate can be obtained based on the target control pulse comprised in the target control pulse sequence, to achieve the target quantum task.

8. The quantum control pulse generation method according to claim 1, further comprising:
obtaining a measurement pulse;
applying the measurement pulse after applying the target control pulse sequence to a target quantum hardware device having the target quantum hardware structure, to obtain state information of respective qubits in the target quantum hardware device; and
verifying and/or optimizing, by using obtained state information of the respective qubits in the target quantum hardware device, the target control pulse sequence for achieving the target quantum task.

9. The method according to claim 8, further comprising:
taking at least the obtained state information of the respective qubits in the target quantum hardware device as an output result; and
displaying the output result in a visual interactive interface.

10. An electronic device, comprising:
at least one processor; and
a memory communicatively connected to the at least one processor, wherein
the memory stores instructions executable by the at least one processor, and the instructions are executed by the at least one processor to enable the at least one processor to:
construct, based on relevant physical parameters of a target quantum hardware structure, a system Hamiltonian of a quantum system characterized by the target quantum hardware structure, wherein the target quantum hardware structure is used to achieve a target quantum task;
obtain an initial control pulse set matching the target quantum hardware structure, wherein the initial control pulse set comprises at least one initial control pulse used to be applied to a qubit in the target quantum hardware structure;
obtain, based on the system Hamiltonian, system state information of the quantum system by simulation, wherein the system state information characterizes state information of the quantum system obtained by simulation after an application of the initial control pulse to the qubit in the target quantum hardware structure; and
optimize the initial control pulse in the initial control pulse set based on at least a relationship between the system state information of the quantum system and target state information that needs to be achieved by the target quantum task, to obtain a target control pulse sequence by simulation, wherein the target quantum task can be achieved after the target control pulse sequence is applied to the qubit in the target quantum hardware structure.

11. The electronic device according to claim 10, wherein the instructions are executed by the at least one processor to further enable the at least one processor to:
obtain preset mapping relationship information, wherein the preset mapping relationship information characterizes a mapping relationship between relevant physical parameters of a quantum hardware structure and an optimal control pulse set; wherein
the obtaining the initial control pulse set matching the target quantum hardware structure comprises:
selecting, based on the preset mapping relationship information, an optimal control pulse set matching the relevant physical parameters of the target quantum hardware structure as the initial control pulse set matching the target quantum hardware structure.

12. The electronic device according to claim 10, wherein the instructions are executed by the at least one processor to further enable the at least one processor to:
perform dynamic evolution processing on the system Hamiltonian based on the initial control pulse comprised in the initial control pulse set for being applied to the qubit in the target quantum hardware structure, to obtain the system state information of the quantum system by evolution.

13. The electronic device according to claim 10, wherein the instructions are executed by the at least one processor to further enable the at least one processor to:
determine a native quantum gate for achieving the target quantum task, wherein the native quantum gate can be obtained from at least one qubit comprised in the target quantum hardware structure; wherein
the optimizing the initial control pulse in the initial control pulse set based on at least the relationship between the system state information of the quantum system and the target state information that needs to be achieved in the target quantum task comprises:
optimizing the initial control pulse in the initial control pulse set in a case that it is determined the relationship between the system state information of the quantum system and the target state information that needs to be achieved in the target quantum task does not meet a preset task rule, to obtain an intermediate control pulse set, simulating a pulse control on the target quantum hardware structure based on an intermediate control pulse comprised in the intermediate control pulse set, to obtain an approximate native quantum gate by simulation, and achieving the target quantum task based on the approximate native quantum gate, wherein a fidelity of the approximate native quantum gate from the native quantum gate meets a preset fidelity rule.

14. The electronic device according to claim 12, wherein the instructions are executed by the at least one processor to further enable the at least one processor to:
determine a native quantum gate for achieving the target quantum task, wherein the native quantum gate can be obtained from at least one qubit comprised in the target quantum hardware structure; wherein
the optimizing the initial control pulse in the initial control pulse set based on at least the relationship between the system state information of the quantum system and the target state information that needs to be achieved in the target quantum task comprises:
optimizing the initial control pulse in the initial control pulse set in a case that it is determined the relationship between the system state information of the quantum system and the target state information that needs to be achieved in the target quantum task does not meet a preset task rule, to obtain an intermediate control pulse set, simulating a pulse control on the target quantum hardware structure based on an intermediate control pulse comprised in the intermediate control pulse set, to obtain an approximate native quantum gate by simulation, and achieving the target quantum task based on the approximate native quantum gate, wherein a fidelity of the approximate native quantum gate from the native quantum gate meets a preset fidelity rule.

15. The electronic device according to claim 13, wherein the instructions are executed by the at least one processor to further enable the at least one processor to:
obtain data characteristic information of a target quantum hardware device to be pulse-controlled, wherein the target quantum hardware device has the target quantum hardware structure; and
perform data calibration on the intermediate control pulse comprised in the intermediate control pulse set, so that a calibrated intermediate control pulse matches the data characteristic information.

16. The electronic device according to claim 13, wherein the instructions are executed by the at least one processor to further enable the at least one processor to:
perform a timing and/or order-based optimization processing on the intermediate control pulse comprised in the intermediate control pulse set in a case that there exist two or more native quantum gates, to obtain the target control pulse sequence by simulation, wherein the approximate native quantum gate can be obtained based on the target control pulse comprised in the target control pulse sequence, to achieve the target quantum task.

17. The electronic device according to claim 10, wherein the instructions are executed by the at least one processor to further enable the at least one processor to:
obtain a measurement pulse;
apply the measurement pulse after applying the target control pulse sequence to a target quantum hardware device having the target quantum hardware structure, to obtain state information of respective qubits in the target quantum hardware device; and
verify and/or optimize, by using obtained state information of the respective qubits in the target quantum hardware device, the target control pulse sequence for achieving the target quantum task.

18. The electronic device according to claim 17, wherein the instructions are executed by the at least one processor to further enable the at least one processor to:
take at least the obtained state information of the respective qubits in the target quantum hardware device as an output result; and
display the output result in a visual interactive interface.

19. A non-transitory computer-readable storage medium storing computer instructions, wherein the computer instructions, when executed by a computer, cause the computer to:
construct, based on relevant physical parameters of a target quantum hardware structure, a system Hamiltonian of a quantum system characterized by the target quantum hardware structure, wherein the target quantum hardware structure is used to achieve a target quantum task;
obtain an initial control pulse set matching the target quantum hardware structure, wherein the initial control pulse set comprises at least one initial control pulse used to be applied to a qubit in the target quantum hardware structure;
obtain, based on the system Hamiltonian, system state information of the quantum system by simulation, wherein the system state information characterizes state information of the quantum system obtained by simulation after an application of the initial control pulse to the qubit in the target quantum hardware structure; and
optimize the initial control pulse in the initial control pulse set based on at least a relationship between the system state information of the quantum system and target state information that needs to be achieved by the target quantum task, to obtain a target control pulse sequence by simulation, wherein the target quantum task can be achieved after the target control pulse sequence is applied to the qubit in the target quantum hardware structure.

20. The non-transitory computer-readable storage medium according to claim 19, wherein the computer instructions, when executed by a computer, further cause the computer to:
obtain preset mapping relationship information, wherein the preset mapping relationship information characterizes a mapping relationship between relevant physical parameters of a quantum hardware structure and an optimal control pulse set; wherein
the obtaining the initial control pulse set matching the target quantum hardware structure comprises:
selecting, based on the preset mapping relationship information, an optimal control pulse set matching the relevant physical parameters of the target quantum hardware structure as the initial control pulse set matching the target quantum hardware structure.
